(19) United States
(12) Patent Application Publication
(10) Pub. No.: US 2003/0191730 A1
(43) Pub. Date: Oct. 9, 2003

(54) Unobtrusive rule-based computer usage enhancement system

(75) Inventors: Barry Adkins, Richmond, TX (US); Vali Ali, Houston, TX (US); Norm Brown, Tomball, TX (US); Art Saxby, Cypress, TX (US)

Correspondence Address: CONLEY ROSE, P.C., P. O. BOX 3267, HOUSTON, TX, 77253-3267, US

(73) Assignee: Compaq Information Technologies Group, L.P., Houston, TX

(21) Appl. No.: 10/117,009

(22) Filed: Apr. 5, 2002

(51) Int. Cl. G21C 17/00; G06F 15/00; G06F 11/30; G06F 9/44; G06F 17/00; G06N 5/02

(52) U.S. Cl. 706/47; 702/186

(57) ABSTRACT

A personal computer usage enhancement system, said usage enhancement system configured to detect usage patterns and if a usage pattern satisfies a trigger threshold, the usage enhancement system suggests methods for improving computer usage that are based on the usage pattern. The usage enhancement system comprises a rules-based engine comprising individual rules for different usage patterns and a message agent for displaying the methods for improving computer usage. The trigger threshold and methods for improving computer usage reside within associated rules. All methods for improving computer usage are transmitted to the message agent to display on an output device. All components of the usage enhancement system are modular and updateable by a backend device configured to download all updates from a network connection. The rules-based engine preferably executes in a highest protection layer of a computer operating system and occupies no more than 1% of the computer system resources.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention generally relates to consumer computer software. More specifically, the present invention relates to a computer software package for enhancing individual computer usage based on use history, system events, hardware profiles, and guidelines, as established by software defined rules that are evaluated, executed, and enforced by a rule based engine.

2. Background of the Invention

Personal computer users often buy personal computers (PCs) off the shelf at retail electronics or appliance stores where computers (including desktop and portables) are often pre-configured with standard, but limited, hardware and software packages. These hardware and software packages are generally designed to be useful to a broad consumer base, which unfortunately translates into systems that are not tailored to an individual consumer's computing needs or desires.

Fortunately, consumers also have the option to purchase more individually tailored computer packages from specialty computer stores or perhaps even from a computer manufacturer's website. Purchases from sources such as these often allow some user interaction to determine the preferred hardware and software packages that may potentially meet the consumer's requirements. For instance, if a user intends to use the computer system to store large amounts of multimedia files, the user may opt to purchase a computer system with one large capacity or multiple hard disk drives. Software packages may also be purchased with same type of logical forethought.

Unfortunately, once the computer system is purchased and delivered for use by the consumer, the computer manufacturer's direct ability to further help end users tailor the system to the end user's needs or desires virtually disappears. Only the most adept end users are aware of potential hardware and software configuration settings that may improve system performance. Similarly, software and hardware upgrades may be available to users but the user may never be aware that these improvements exist or that incorporating such upgrades may improve computer enjoyment or maximize efficiency. In short, many end users end up working strictly within the confines of the resources packaged in the original computer system. While these resources may be sufficient for a particular user, it is certainly feasible that the system hardware and software may be configured to operate more effectively for that user.

Furthermore, while the original system may have been individually tailored to a consumer's requirements, this tailoring is based on requirements as they were understood at the time of purchase. It is quite likely that computer usage, needs, and interests progress and change. Over time, usage patterns may change and new software or new hardware may be added to a computer system. New features are likely added in piecemeal fashion, which means that new device drivers and software may be added with new hardware, but many of the original configuration settings will likely remain the same. Similarly, existing hardware and software may not be fully optimized to run with the new hardware or software. In such cases, many users will not be apprised of possible improvements that may be made to the existing system to aid in the enjoyment of newly added features. Thus, users may perceive these unimplemented improvements as setbacks or limitations of the existing system, which may lead users to consider purchasing a new computer system when, in fact, the existing system may be fully capable of operating to the user's satisfaction.

Some solutions to the above mentioned problems have been proposed, but these conventional solutions use continuously running software programs involving active polling schemes to monitor computer usage. These polling schemes typically involve queries to specific portions of a computer system to determine device status. For instance, a software application may query an optical drive to check the existence of removable media in that drive. Unfortunately, these polling schemes also consume processor, memory, bus, and perhaps even network resources. While these conventional solutions work well in enterprise computing solutions where resources are plentiful or can be accounted for in creating the information technology (“IT”) infrastructure for business computing systems, they do not translate well into home computer systems, which have limited resources. Consequently, the conventional approaches impose inordinate demands on home computer system resources so as to become obtrusive and more of a hindrance than a help. As a result, individual users of these conventional monitoring systems often disable the system to free up those resources used by the monitoring software.

Furthermore, since enterprise systems run around the clock and are always connected to the internet, much of the periodic polling and updating can be scheduled during off-peak periods. By comparison, many home PC users only power up their computers during actual use. The computer is shut down the rest of the time. Network and internet updates are especially problematic for home PC users with dial-up internet connection accounts, because these users only access the internet for a fraction of the time the computer is on. As such, network updates cannot be implemented as easily on home computers as they are in enterprise solutions, which are constantly connected to a network.

One related solution that seeks to provide users with updated, context-sensitive computer information has been proposed by Aveo and ITS Corporation in the form of a software package called “Attune”. Attune seeks to provide PC users with specialized information regarding their particular computer such as driver or software updates. One major limitation to this software package is that it only provides information regarding existing, static configurations as opposed to offering improvements based on time-dependent usage patterns. For instance, Attune may provide advance warning (in the form of a message called an Intelligram) of a known hardware conflict with a new software program the user is attempting to install.

While this prior art solution certainly offers the advantage of allowing users to potentially avoid problems, it does not attempt to gather information about computer usage patterns and ways to improve efficiency and enjoyment, based on the user's system usage model. For example, if the system detects that the end user works extensively with digital pictures (scans, edits, etc.) and that a large digital picture library exists on the user's hard drive, the system may suggest various options to the users. In one instance, if a CD recordable drive (CD-R/CDRW) or ZIP drive is present, the system may prompt or remind users to back up their pictures and data to removable media. In the absence of such a device, the system might recommend purchasing a CDRW drive or, alternatively, offer a web-based repository service for storage, cataloging, and even printing services offered by business partners. Such a solution provides a tiered rule approach to analyzing system usage and offering ways to improve efficiency and may offer improvements over a statically defined rule system that only evaluates a gives set of rules on a periodic basis.

Thus, despite the effectiveness of the presently known monitoring techniques, it would be desirable to create an unobtrusive computer usage monitoring system that can provide suggestions on ways to improve enjoyment and efficiency of a computer system. Such a system would advantageously minimize the system resources used in monitoring system use, thereby permitting continuous determination of ways to improve system usage.

Furthermore, it is also desirable that the software system be capable of independently performing enhancements (upgrades) to the software or for providing new ways of enhancing the user's experiences, especially as the usage patterns and system configuration changes over time. For example, once an action has been performed by the user, that specific rule or data gatherer is potentially no longer relevant and may be temporarily discarded. Similarly, new rules based on the presence of newly added software or hardware may be available. An improved usage enhancement system should therefore be capable of upgrading itself to acquire new, but pertinent and applicable rules for a given system.

An additional goal of the usage monitoring and enhancement system is that privacy and confidentiality be preserved and that any information gathered by the system should be limited to generic usage data. Thus, while it may be desirable to gather usage profiles for multiple users of a single machine, said data should preferably NOT be used for unique identification purposes.

### BRIEF SUMMARY OF THE INVENTION

The problems noted above are solved in large part by a computer usage enhancement system configured to execute on a personal computer system and further configured to detect computer usage patterns, system events, and system configuration. If a usage pattern and/or a system event satisfies a trigger threshold, the usage enhancement system suggests methods for improving computer usage that are based on the usage pattern. At a minimum, the usage enhancement system comprises a rules-based engine with individual rules for different usage patterns and a message agent for displaying the methods for improving computer usage. The trigger thresholds and methods for improving computer usage for a given rule reside within that rule. Individual rules are preferably written in XML for easy and open (standards-based) authorship and parsing of the rules for execution and assessment on a variety of systems. The components of the usage enhancement system and the individual rules within the rules-based engine are preferably modular and updateable by a backend device configured to download all updates from a network connection. The rules-based engine executes in a highest protection layer of a computer operating system and occupies no more than 1% of the computer system resources.

When the rules-based engine determines that a usage pattern satisfies the trigger threshold, the rules-based engine transmits the methods for improving computer usage to the message agent. The message agent then displays an alert message on the output device indicating that methods for improving computer usage exist. When the message agent displays the alert message, a computer user may elect to disable the alert message or to implement the methods now or at a later time. If a computer user elects to implement the methods for improving computer usage, the usage enhancement system instructs the user on how to incorporate the methods for improving computer usage and the usage enhancement system also automatically incorporates any methods for improving computer usage that do not require user interaction. On the other hand, if a computer user disables the alert message, the rules-based engine deactivates the rule that generated the alert message.

The usage enhancement system further comprises an activity guide that provides grouped actions that relate to computer user interests. The grouping of actions in the activity guide is configurable by the customer and also by the results of the usage pattern detection performed by the rules-based engine.

The rules-based engine preferably operates by passively monitoring the usage patterns by detecting operating system messages, events, and interrupts. Minimal amounts of active monitoring can be performed by polling hardware devices and software applications, but said active polling methods preferably use no more than 1% of the personal computer system's resources.

Updating the usage enhancement system involves comparing version information for components of the message agent, the activity guide, and the rules-based engine, including individual rules, against the latest version of each component available on a computer network. If any components are not the latest version, the components can be updated whenever the personal computer is connected to the network. The network may be a simple internet connection and updates may be available from a rules repository or some other internet website.

The rule-based computer usage enhancement system is preferably embodied as an extensible software package comprising a rule-based engine to detect and gather computer usage patterns, rules interpretable by the rule-based engine related to specific usage types, and triggers within the rules that establish a threshold level for specific usage patterns above which suggestions may be made to a computer user on ways to improve computer usage. All components of the software package preferably reside on a single computer system and occupy less than 10% of the computer system resources while the software package executes. Ideally, the software package occupies no more than 1% of system resources while executing on the computer system.

The software package includes a core rule engine that executes permanently as a system service, executable rule engine extensions that load and run only when called by a rule and that are released after execution. The rule extensions are responsible for providing usage pattern information to the rule engine. The software package also includes a base rule engine extension that executes permanently that gathers minimal information for the core rule engine. Further components include a parser for interpreting the rules, which are preferably written in XML, and an evaluator for comparing trigger thresholds with usage pattern information provided by the rule engine extensions. The rule extensions may provide usage pattern information from hardware devices or from software applications.

The suggestions for improving computer usage offered by the software package may be tailored to individual computer users or may apply to all users or any combination thereof. Preferably, a common set of rules are installed in all computers, but only those rules relevant to the computer system configuration and usage are activated. All other rules are deactivated.

The core rule engine that executes permanently as a system service controls multiple threads, including a system monitor thread for monitoring operating system messages, events and interrupts, a device change thread for monitoring device hardware and device media changes, a time monitor thread for periodically polling device status, and a special registered thread for monitoring individual hardware devices or software applications. All rules are registered with one of the threads and prioritized for execution by the system service.

### BRIEF DESCRIPTION OF THE DRAWINGS

For a detailed description of the preferred embodiments of the invention, reference will now be made to the accompanying drawings in which:

FIGS. 1a and 1b show examples of representative personal computer systems in which the preferred embodiment may be implemented;

FIG. 2 shows a block diagram of a personal computer system in which the preferred embodiment may be implemented;

FIG. 3 shows a schematic displaying a typical hardware and software layer architecture of a personal computer system in which the preferred embodiment may be implemented;

FIG. 4 shows a diagram of the fundamental components in the preferred embodiment;

FIG. 5 shows a more detailed diagram of the functionality of the preferred embodiment; and

FIG. 6 shows a representative implementation of the rule-based engine architecture in the preferred embodiment.

### NOTATION AND NOMENCLATURE

Certain terms are used throughout the following description and claims to refer to particular system components. As one skilled in the art will appreciate, computer companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”.

### DETAILED DESCRIPTION OF THE PREFERRED EMBODIMENTS

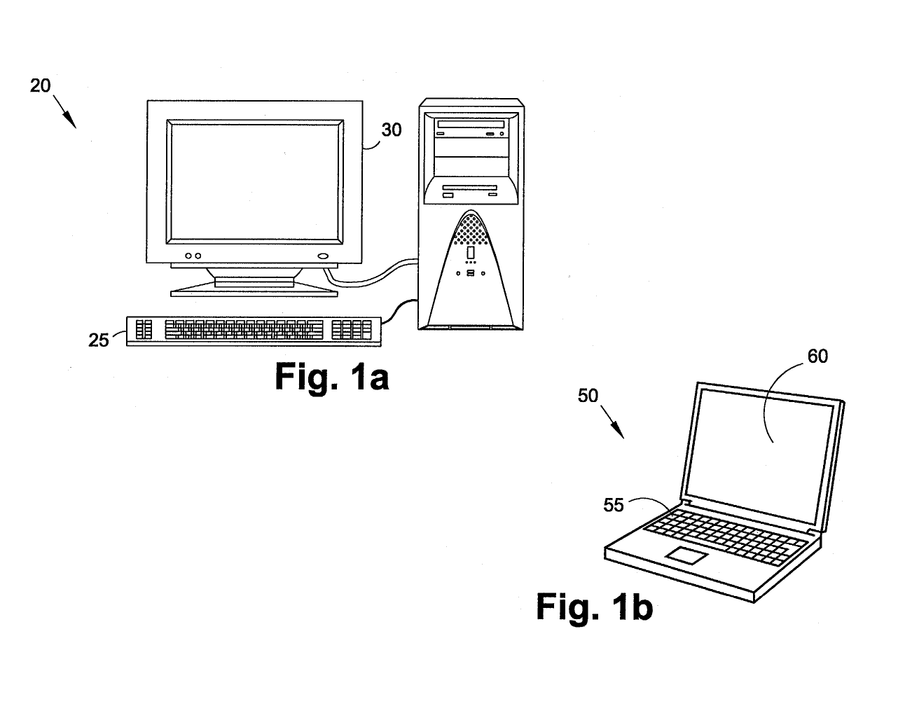

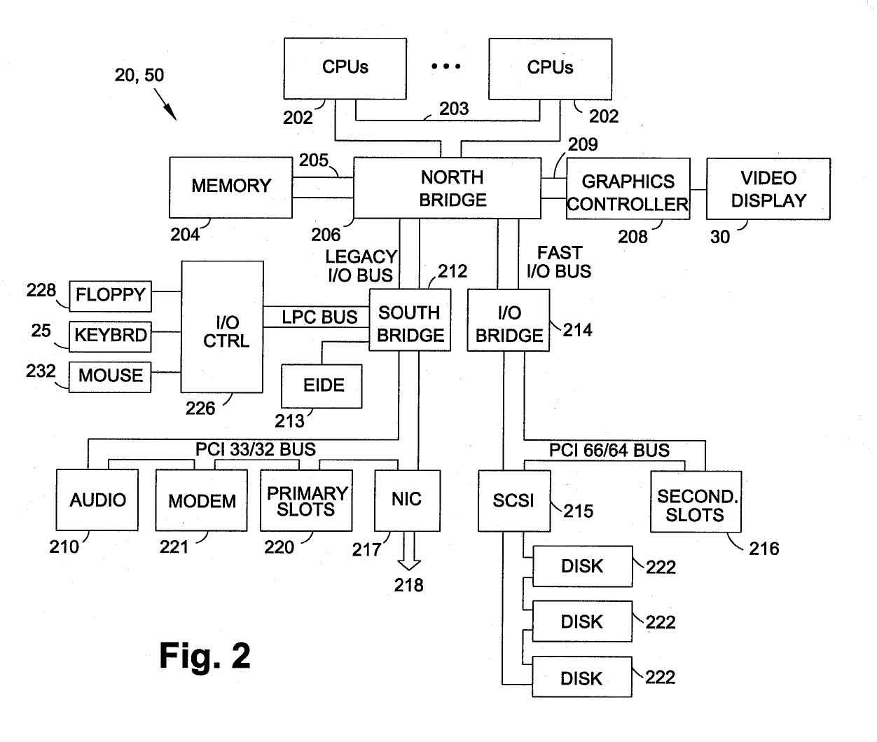

Turning now to the figures, FIGS. 1a and 1b show examples of a desktop computer system 20 and a portable computer system 50, respectively. Each of these computer systems 20, 50 represent the type of computer system typically purchased by individuals and home users. Each computer system 20, 50, preferably includes a keyboard input device 25, 55 and a video display device 30, 60. Other peripheral input or output devices such as a mouse, scanner, or printer may be coupled to the computer systems 20, 50, but are not specifically shown in FIG. 1. The personal computer systems shown in FIG. 1 are configured to operate independently of any computer network, but are preferably equipped with at least one network connection device shown in FIG. 2 and discussed below.

Referring now to FIG. 2, a schematic representation of computer system 20, 50 in which the preferred embodiment may be implemented is illustrated. It is noted that many other representative configurations exist and that this embodiment is described for illustrative purposes only. The computer system of FIG. 2 preferably includes one or more CPUs 202 coupled to a bridge logic device 206 via a CPU bus 203. The bridge logic device 206 is sometimes referred to as a “North bridge” for no other reason than it often is depicted at the upper end of a computer system drawing. The North bridge 206 also preferably comprises a memory controller to access and control a main memory array 204 via a memory bus 205 and may further couple to a graphics controller 208 via an accelerated graphics port (AGP) bus 209. The graphics controller 208 drives the video display 30. The North bridge 206 couples CPU 202, memory 204, and graphics controller 208 to each other and to various peripheral devices in the system via one or more high-speed, narrow, source-synchronous expansion buses such as a Fast I/O bus and a Legacy I/O bus. The North bridge 206 can couple additional “high-speed narrow” bus links other than those shown in FIG. 2 to attach other bridge devices and other buses such as a PCI-X bus segment to which additional peripherals such as a 1 Gigabit Ethernet adapter may be coupled. The embodiment shown in FIG. 2 is not intended to limit the scope of possible computer architectures.

The Fast I/O bus shown in FIG. 2 may link the North bridge 206 and an I/O bridge 214 that provides access to a high-speed 66 Mhz, 64-bit PCI bus segment. A SCSI controller 215 may reside on this high speed PCI bus and manages multiple fixed disk drives 222. In the alternative, the disk drive controller 215 and internal drives 222 may also be coupled to the primary 32-bit 33 Mhz PCI bus. The high speed PCI bus also provides secondary expansion slots 216 that permit coupling of peripheral devices that comply with the high speed PCI bus.

The Legacy I/O bus is preferably used to connect legacy peripherals and a primary PCI bus via a separate bridge logic device 212. This bridge logic 212 is sometimes referred to as a “South bridge” reflecting its location vis-à-vis the North bridge 206 in a typical computer system drawing. An example of such bridge logic is described in U.S. Pat. No. 5,634,073, assigned to Compaq Computer Corporation. The South bridge 212 may provide access to an EIDE controller 213 for connection to a CD-ROM device (not shown) and provides a low-pin count (“LPC”) bus to legacy peripherals coupled to an I/O controller 226. The I/O controller 226 typically interfaces to basic input/output devices such as a floppy disk drive 228, a keyboard 25, a mouse 232 and, if desired, various other interfaces such as parallel or serial data ports (not shown). The South bridge 212 also may provide one or more expansion buses, but preferably provides a 32-bit 33 Mhz PCI bus segment on which various devices are disposed.

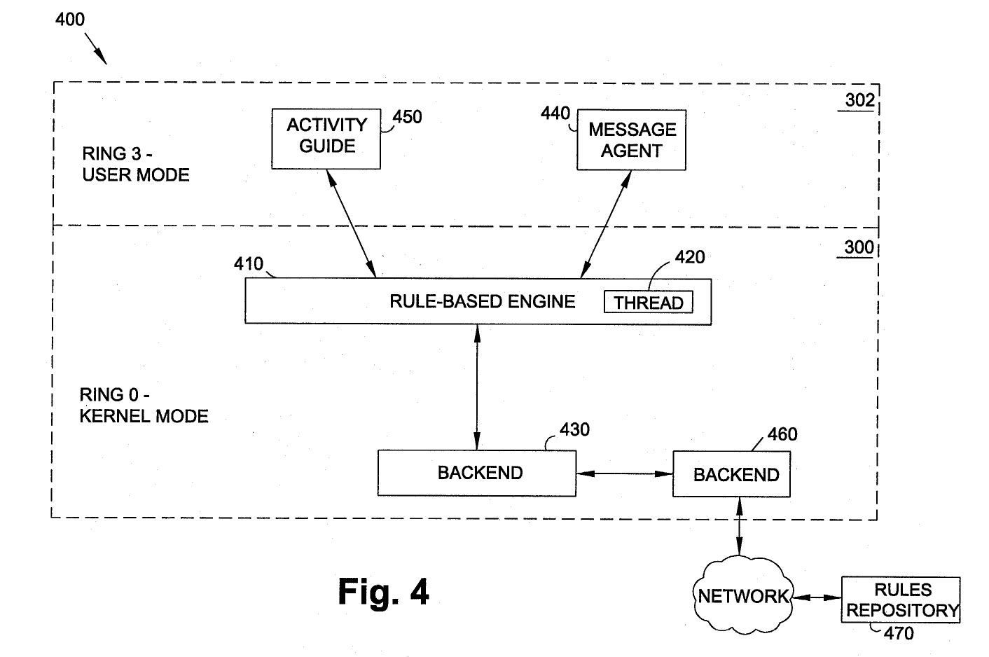

Various components that comply with the bus protocol of the 33 Mhz, 32-bit PCI bus may reside on this bus, such as an audio controller 210, a modem 221, and a network interface card (“NIC”) 217. Alternatively, the audio controller 210 and modem 221 may reside on a single device in compliance with Intel's Audio Codec '97 (AC97) Component Specification. In yet another alternative embodiment, the modem may be implemented as a software modem. The NIC 217 preferably comprises an ethernet controller and can be coupled to a network 218 for communication with other computers. In the preferred embodiment, modem 221, NIC 217 and other circuitry related to the preferred embodiment may be installed on the computer's motherboard as presumed by FIG. 4. However, it should be recognized that the network connection components described herein may be provided on an expansion card or even external to the computer 20, 50. In either case, the computer 20, 50 is configured to communicate with an external network and/or the internet using modem 221 or NIC 217. Modem 221 may be used to connect to the internet using a dial-up or ISDN connection while the NIC 217 may be used to connect using a broadband technology such as a Digital Subscriber Line (DSL) connection. Other connection means not specifically shown may also be used, including cable modems or IEEE 802.11x wireless devices. All such variations are contemplated to be within the scope of the preferred embodiment described herein and will be recognized by those skilled in the art.

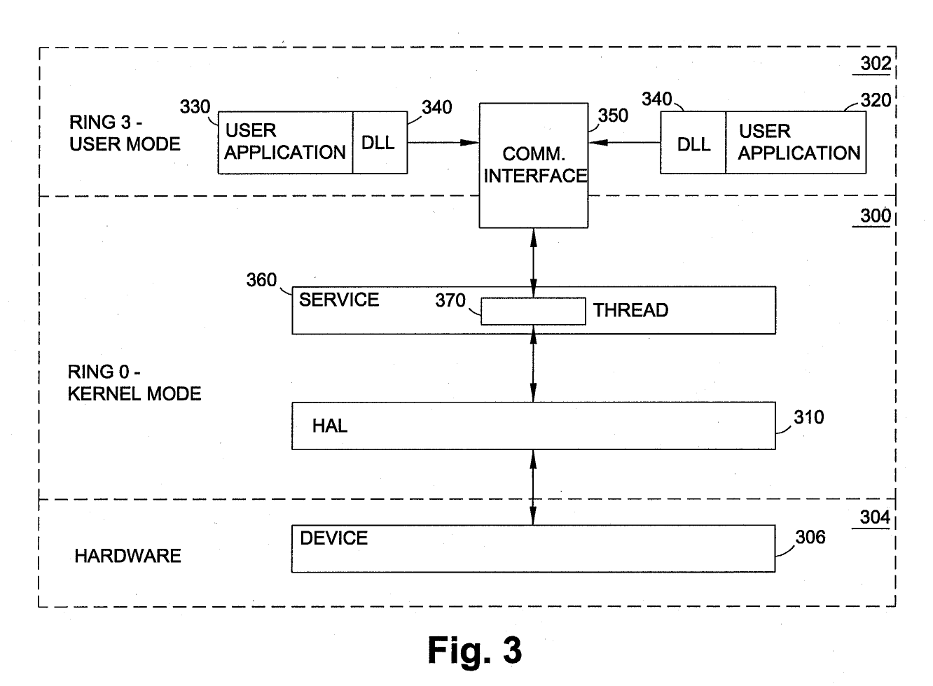

Referring now to FIG. 3, a schematic showing the system architecture of the preferred embodiment is shown. The preferred embodiment is described for, but not limited to, a Windows NT or XP environment. Architectures in Windows 9x and ME operating systems include more Ring layers than that shown in FIG. 3, but for the purpose of this description of the preferred embodiment, are substantially similar. Furthermore, it should also be noted that the architecture described herein is provided to disclose the preferred embodiment and is not intended to limit application of the preferred embodiment to any particular operating system. Other computer operating systems such as those offered by Sun, Apple, or Red Hat and other Linux providers may also provide a suitable platform on which to implement the preferred embodiment.

The three main levels shown in FIG. 3 represent the hardware/software protection layers in a conventional computer system running the Windows NT and Windows XP operating systems. The XP environment provides two software protection levels: Ring 0 protection level 300 and Ring 3 protection level 302. Other operating systems may provide more protection levels. The Ring 0 protection level 300, sometimes called the “kernel” or “supervisor” mode, is the most highly protected ring in which an application or service can run. The Ring 3 protection level 302, sometimes called the application level or user mode, is the least protected ring. Applications running in the Ring 3 protection level 302 cannot physically access memory space in the more highly protected Ring 0 layer 300. Any communication between applications running in the Ring 3 layer 302 and services in the Ring 0 layer 300 must use a communications or message passing interface. This design prevents user applications from interfering with the core XP operating system.

Also shown in FIG. 3 is a Hardware layer 304, which represents the physical computer system devices 306 such as the CPUs, data drives, and memory. Also included in FIG. 3 is a Hardware Abstraction Layer (“HAL”) 310, which is used to prevent hardware dependence and provide an isolation layer between the hardware and software. This layer serves, in part, to permit operating systems to run on a variety of platforms. The HAL 310 operates at the Ring 0 level and translates low-level operating system functions into instructions understandable by the physical system hardware.

Another aspect of FIG. 3 that is common to conventional NT/XP system architectures is the location and execution of user applications, such as applications 320, 330 in the Ring 3 protection layer. As discussed above, the protection levels are set up to ensure a stable operating system environment. In order to provide access to shared OS functions and data structures, a set of dynamic link libraries (“DLL”) 340 are linked as extensions to the applications. DLLs 340 are executable modules that contain functions and data and generally provide a way to modularize applications so they can be loaded, updated, and reused more easily. The DLLs 340 may be shared between applications 320, 330 or may be uniquely related to a particular application. The applications 320, 330 and DLLs 340 are typically linked at application load time. Furthermore, a communications interface 350 is used to permit communication between the applications 320, 330 in the application layer 302 and kernel mode services 360 in the Ring 0 layer 300. The communications interface 350 may be implemented using shared memory queues, which transmit communication signals as well as manage any asynchronous inter-layer timing differences.

A user application 320, 330 typically interfaces with a computer user through a graphical user interface (GUI). By comparison, a kernel mode service 360 is a process which does not require user interaction and may therefore operate in the background using minimal resources. Services 360 typically start when the computer system 20, 50 boots up and may be started from a services applet or in response to another application. Services 360 operate closer to the hardware layer (i.e., in the Ring 0 layer 300) than user applications 320, 330. However, both user applications 330, 340 and services 360 run threads 370 to interact with the operating system. A thread 370 is the basic unit to which the operating system allocates processor time. There is at least one thread 370 for each running service 360, but a service may create more threads when needed.

Referring now to FIG. 4, the above described architecture will now be supplemented with a description of the unique aspects and advantages of the preferred embodiment. The preferred usage enhancement system 400 comprises a rules-based engine service 410, a backend 430, and two user applications referred to as a message agent 440 and an activity guide 450. The usage enhancement system 400 preferably is implemented as software that executes on CPU 202. The rules-based engine 410 is preferably capable of executing one or more system threads 420. The preferred usage enhancement system 400 allows computer manufacturers to provide users with updated system information as well as suggestions for enhancing the user's computing experience. In general, the preferred embodiment 400 seeks to continuously improve the efficiency and enjoyment of the PC 20, 50. The rules-based engine 410 preferably comprises a set of rules that determine when to send usage enhancement messages via the message agent 440 to the computer user. All rules and components of the usage enhancement system are modular and may be monitored and updated by the backend 430.

Ideally, the preferred usage enhancement system 400 allows PC customers to accomplish and enjoy relevant activities with a tool that becomes personalized to each individual computer. The usage enhancement system 400 uses the intelligent rules-based engine 410 to recommend specific actions or provide offers to the PC user to improve and personalize the system. In general, the preferred embodiment also advantageously offers a communication vehicle between the PC manufacturer and end user.

The rules-based engine 410 preferably contains the logic and decision making structure that determines whether and when to alert a customer with relevant information. The rules-based engine 410 preferably continuously gathers system information and data and analyzes this information against defined rules within the rules-based engine 410. System hardware and software are monitored and interrogated for usage, use characteristics, function, state, and condition. From the data and usage patterns, the rules-based engine 410 performs an analysis and determines a course of action to improve efficiency for the user and the system. Alternatively, the rules-based engine may determine an appropriate course of action to correct an identified problem.

The rules-based engine 410 is preferably employed and operates based on configurable criteria defined in individual rules using an extensible markup language (XML). Other markup languages such as the Standard Generalized Markup Language (SGML) or other high level coding languages may also be employed. The rules-based engine 410 operates on a variable number of rules that may be deployed at any time using a continuously repeatable software update process, which will be described in further detail below. Each rule is defined to analyze individual problems or groups of closely related problems. Each rule also preferably includes a trigger that serves as a threshold to determine whether any action needs to be taken based on the system information gathered by the rules-based engine 410. In the event a trigger is activated, a solution is offered to the user and depending on whether the user accepts the solution, further action may be implemented.

One non-limiting example of a rule that may be implemented in the preferred embodiment is a battery usage rule in a portable computer 50. If the rules-based engine 410 detects frequent, extended battery usage and if the duration and/or frequency of this battery usage exceeds the threshold level within the individual rule, the usage enhancement system 400 will generate a message via the message agent 440 presenting the user with information on the availability of longer life batteries. The message may also provide a direct means of ordering a new battery. Additionally, the message may offer methods of reducing system power usage to increase use time with the existing battery. In either case, the usage enhancement system 400 analyzes existing usage patterns and, based on these patterns, offers the user a method of improving usage by extending battery life on the portable computer. Numerous other aspects of the computer system 20, 50 can be monitored as well. Examples include, memory usage, internet browsing history, image, audio, and video editing or playing, laptop usage, printer usage, re-writeable media usage, and many others.

It should be noted that triggers that determine how and when to recommend improvements are preferably not independent of one another. When a first trigger is satisfied, the preferred embodiment may, in addition to generating a user message, initiate the evaluation of a dependent set of additional rules/criteria that could be evaluated for a given user's system. For example, a first rule may be used to detect free hard drive space. If free space is limited, a data archival process may be warranted. Hence, a second rule may then check for the presence of a CDRW and in the absence of such a device, a third rule may check for internet connectivity for web based storage solutions. This tiered, dependent rule capability allows the preferred embodiment to offer improvement suggestions that are truly based on existing usage patterns and system profiles.

The usage enhancement system 400 preferably recommends specific actions and provides offers to the user via the message agent 440. Such offers may advantageously improve and personalize the customer's computing and internet experience. The message agent 440 displays specific messages to the user according to their priority. Accordingly, some messages may be more urgent (i.e., reflecting a higher priority) and will be displayed before lower priority messages. Furthermore, messages may apply to specific users or to all users of a specific system.

Users are preferably allowed to respond to potential solutions through an unobtrusive interaction with the message agent 440. Messages delivered through the message agent 440 preferably include consistent action choices, including options to remind the user later, to disable the current message, or to read further information regarding the current message. In the event a user acts on a solution, the user is guided through actions that require user intervention. On the other hand, any actions that can be performed automatically by the usage enhancement system 400 will be implemented automatically. It should be noted that if a user opts to disable a message that appears on the screen, the usage enhancement system 400 preferably disables the rule that generated the message. This characteristic of the preferred embodiment complies with the goal of minimizing the number of interruptions a user sees while working on the PC 20, 50. By minimizing these interruptions, users are theoretically less likely to disable the usage enhancement system altogether.

Referring still to FIG. 4, another aspect of the preferred embodiment is the backend portion 430 of the software solution. As noted above, the usage enhancement system and individual rules are completely modular and updateable. The backend preferably operates discretely and without any user intervention to determine missing rules or components and downloads any necessary information whenever the user is connected to the internet. The necessary internet connection may be made through an appropriate device driver 460 controlling a network device such as a software or hardware modem 221 or NIC 218.

The backend 430 communicates via a network or other rules repository 470 and is capable of determining when and where updates to software, rules, messages and activity guides are available. The rules repository server 470 may be operated by the PC manufacturer, a third party application service provider or other entity. In addition to downloading these updates, the backend 430 may also be configured to gather statistics about system use and transmit such information to the PC manufacturer. Thus, the collaborative effort between the backend 430 and a rules repository server guarantee that proper data is delivered to the correct users and tracked accordingly.

For example, new rules based on the presence of a newly installed CDRW system might now be relevant for the users system. If data protection is a concern, new software applications, including perhaps a high end backup solution, or a periodic/automatic data backup solution may be recommended as a potential use of the CDRW drive. The latest versions of third party software solutions and information links may be updated on a regular basis and the backend 430 can effectively download these and other updates on a regular basis.

It should be noted that while information is gathered about the specific usage patterns and system configurations, a user's privacy and confidentiality are preserved. The proposed usage enhancement system preferably ensures that the gathered data is NOT transmitted to the computer manufacturer (or any business partners) for the purposes of commercial (or other) gains. If any user information is shared, it is preferably done so only with explicit and implicit user consent. Further, the shared information should be limited to a generic usage data and not specific to a user or a system so that the information is NOT be used for unique identification purposes.

Conventional techniques for updating the system rules or software upgrades may be applied in the preferred embodiment. An example of a similar system is the “LiveUpdate” system used by Symantec Corporation to download anti-virus software updates and updated virus definitions to individual PCs. This method of updating system components permits background updates that minimize intrusion into computing and internet sessions. It is envisioned that in the preferred embodiment, consumers will not be able to disable the automatic update process, but a disable feature may be incorporated to offer users more flexibility in controlling the operation of the usage enhancement system. Furthermore, it may be desirable to include a bandwidth limiter during downloads executed by the backend so as not to saturate the user's internet connection, especially in the case of low bandwidth 28K or 56K dial-up connections. The backend may also incorporate a resume feature that will permit downloads across multiple internet sessions. This feature is useful in the event the user terminates an internet connection in the middle of a download. All such variations are known to those skilled in the art and are intended to be within the scope of this description of the preferred embodiment.

The final component of the preferred embodiment shown in FIG. 4 is an activity guide 450. The activity guide 450 preferably provides an activity-based interface designed to help customers use their PCs 20, 50 and internet more effectively. The activity guide 450 may present customers with a list of actions that relate to any given activity. These actions may include launching related applications or going to an internet website that supports the selected activity. For instance, if a consumer is active in downloading photos from a digital camera, the activity guide may offer a group of icons related to camera drivers, scanner drivers, photo editing software, photo album software, and links to internet websites on digital photography. An infinite number of other activity guide groupings are possible based on individual hardware configurations and usage patterns. Other examples may include groups of gaming activities, digital music or video activities, website development activities and so forth. Activities and actions presented in the activity guide 450 are preferably configurable by the customer and configurable based on the results of decisions made by the rules-based engine 410. It is envisioned that the majority of a customer's contact with the usage enhancement system 400 is likely to come from interaction with the activity guide 450.

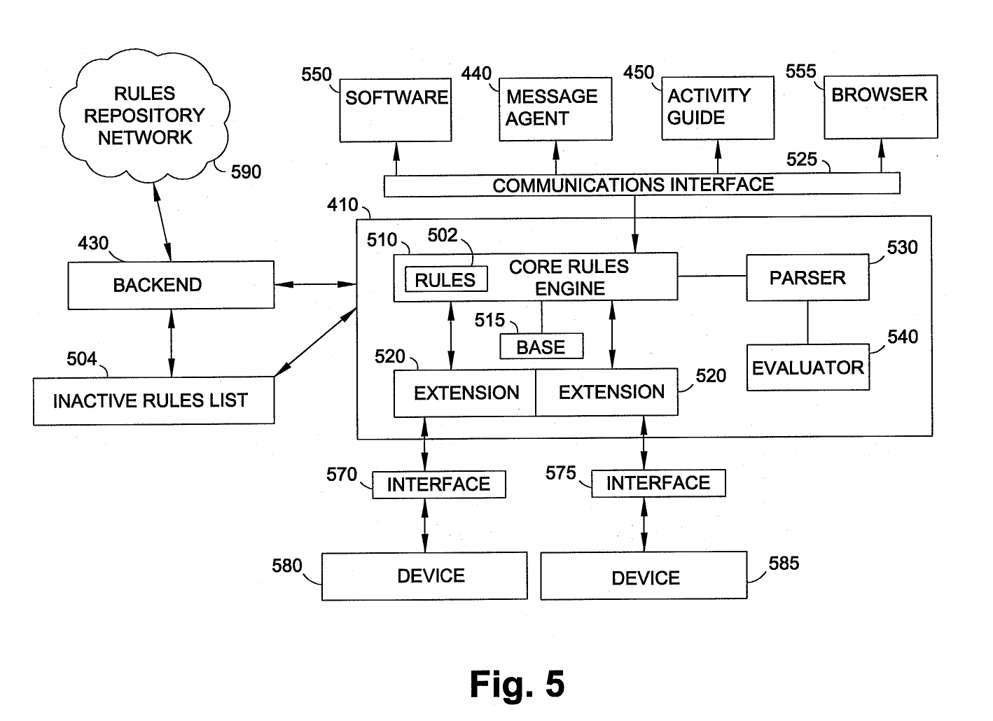

Referring now to FIG. 5, additional aspects of the preferred usage enhancement system 400 are shown. The rules-based engine 410 is preferably comprised of a number of rules 502 that determine when suggestions for usage enhancement should be offered to the computer user. In order to minimize user intrusion, the rules-based engine 410 preferably runs silently as a system service that loads and processes initial rules at system startup. That is, the rules-based engine 410 preferably has no user interface. It should also be noted that in multi-user environments such as those provided in Windows NT, 2000, and XP, the rules-based engine 410 may load and process rules regardless of whether a user is logged in. Furthermore, rules within the rules-based engine 410 may be targeted to all users or specific users of a PC. It is further envisioned that the rules-based engine 410 occupy less than 10% of system resources (i.e., bus, processor, memory) while running and preferably no more than 1% of system resources.

The rules-based engine 410 preferably comprises a core rules-base engine 510 and any number plug-in style rule extensions 520. The core engine 510 preferably comprises a set of resident rules 502 that are active for a specific computer. The rules-engine 410 also preferably has access to a number of inactive rules 504 that may reside on a local hard drive, but may be inactive because they are unrelated or irrelevant to the current hardware, software or usage configuration. For instance, a rule related to scanner device usage may be deactivated if no such device resides on the system. Accordingly, rules 502, 504 may be activated or deactivated as required by configuration changes. This configuration permits a common set of rules to be installed or downloaded to all computer systems. Once installed, the local rule-based engine 410 may then determine which rules to activate based on system configuration.

Each rule 502 preferably contains all necessary information for the rules-based engine 410 to interpret the rule. For instance, each rule may include version information, binary executable extensions 520 that are used to return information to the rules-based engine 410, and any text, graphics, or images to be displayed to the user via the message agent 530. The rules may also include attributes such as a rule identification ID to correctly identify a rule and an active flag to indicate whether the rule is active. Each rule may also include display and execution prioritization levels so that the rules-based engine 410 can determine the order with which to process the rules and, if necessary, alert users as to potential actions to be taken as a result of the rule. As mentioned above, the preferred language for the individual rules is XML. The rules-based engine 410 also preferably includes (or has access to) a parser 530 that performs the actual XML interpretation. An example of a suitable parser usable in the preferred embodiment is the msxml.dll parser readily available from within Microsoft Windows operating systems.

Whereas the core rules engine 510 runs continuously as a system service, the rule extensions 520 are only used intermittently to gather data used to evaluate a rule. The rule extensions 520 may be .COM, .EXE., or .DLL executables that are capable of returning information such as the size of a page file or the rotational velocity of the hard drive to the rules-based engine 410. When a rule is not being actively processed, the extensions 520 are preferably not resident in memory. Any extensions 520 used by a given rule are preferably loaded prior to processing the rule and released when no longer needed. In general, there may be more than one extension for a given rule.

The rule extensions 520 preferably gather the information necessary for individual rules through an interface 570, 575 between the rules-based engine 410 and the device 580, 585 from which the information is to be gathered. The hardware interface 570, 575 may be a device driver or some other abstraction means for gathering the required information. For instance, devices 580 and 585 may represent a printer and an optical disk, respectively. In such a case, the rules-based engine extensions 520 may passively detect or actively poll information from the appropriate printer or pass through drivers 570, 575. Passive detection is preferable because the rules-based engine 510 may simply monitor communications that occur between other applications, drivers, and hardware without occupying additional system resources. It is preferable that active polling of devices be kept to an absolute minimum to comply with the goal of using minimal resources. However, in some instances, it is absolutely necessary to poll a device such as a hard disk drive to gather device failure warnings. In such cases, it may be adequate to poll a limited number of times in a given period (e.g., once a month).

Referring still to FIG. 5, the rules-based engine 410 preferably incorporates a base “extension” 515 that is preferably always resident in memory. This base extension 515 is capable of gathering a minimal amount of system information, including day/time information, OS version information, rules-based engine software versions. The base extension 515 may also gather other information from devices or software that generally exist on most computer systems such as display devices, word processing software or the existence and type of internet connection available.

In addition to gathering information from devices, the preferred embodiment may also detect information from user applications 550, 555. Examples may include audio playback software 550 or internet browsers 555. Information from these types of user applications may be used to determine usage patterns such as whether digital music is played or edited often or the frequency with which certain websites are visited. As with the device interfaces 570, 575, the rules-based engine 410 also uses an application communication interface 525 of the type shown in FIG. 3 (350) to retrieve relevant application or usage information. In general, the preferred usage enhancement system is capable of gathering software, hardware, and usage information from any of a number of different sources, including both software applications and hardware devices, as will be described in further detail below.

Once instructions and threshold triggers within a rule 502 are interpreted by the parser 530, an evaluator 540 is employed to perform the comparison specified in that rule. The evaluator may reside within the rules based engine or may be embodied externally as a shared DLL library that has many entry points. Furthermore, there may be more than one evaluator in any given PC. If an internal default evaluator 540 is used, it may be possible for individual rules to specifically request external evaluators, in which case, the default evaluator 540 is bypassed in favor of the specified evaluator.

Given the modular nature of the preferred embodiment, all components of the usage enhancement system 400, including all rules, parsers, extensions, and software updates may be downloaded (i.e., updated) by the backend 430. The backend 430 preferably maintains a version database for all components and periodically checks this information against the latest versions available from a rules repository server 590. As mentioned above, all updates occur when the user connects to the internet. It may also be feasible to download updates from a variety of locations, especially if third party rules, parsers, libraries, or evaluators are used. If this is the case, it may be advantageous for the various components to include (in addition to a version number) a URL or some other internet location where updates may be found.

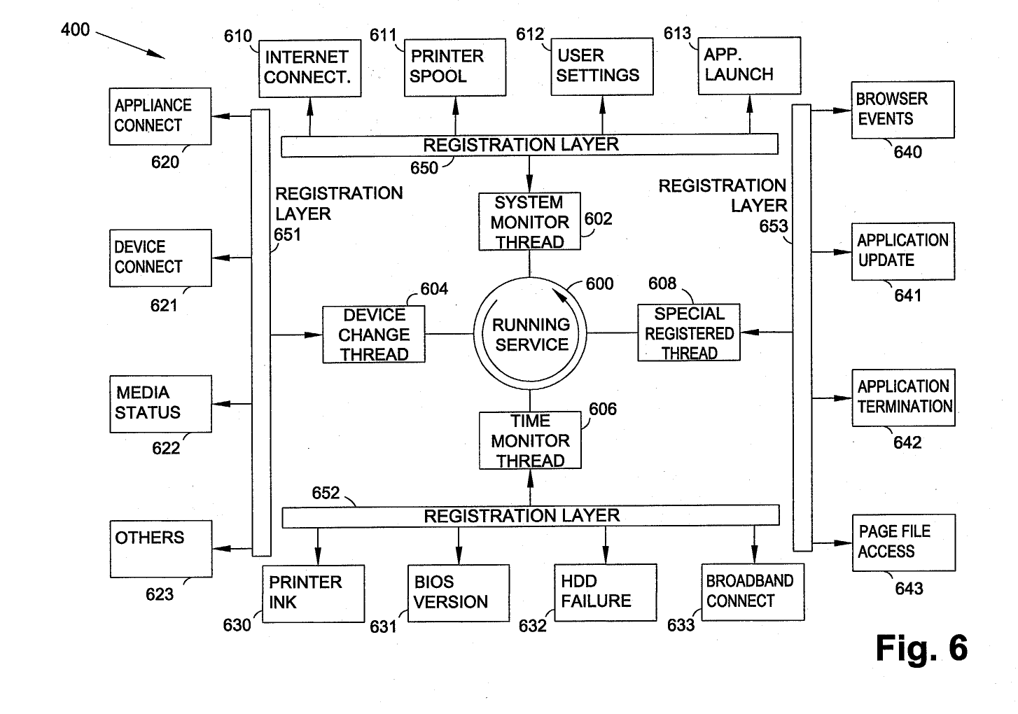

Referring now to FIG. 6, a representative implementation of the core rule-based engine architecture 510 is shown. At the center of FIG. 6, the core rules-based engine 510 includes a service 600, preferably running in a protected layer of a computer operating system. The rules engine 600 preferably starts and controls a plurality of system threads 602-608 and creates a registration layer 650-653 between the service 600 and various rules. Each thread is preferably configured to monitor whether rules are actively registered and ready to be evaluated. Once a rule is registered, the appropriate thread provides the service 510 with information such as which rules are active as well as rule prioritization and the frequency with which a rule should be analyzed. With this information, the preferred rules-based engine can determine the order in which to process and analyze the various rules.

In accordance with the preferred embodiment, one of at least four different threads may be employed. These threads include a system event monitoring thread 602, a device change notification monitoring thread 604, a timer based trigger monitoring thread 606, and a special registered events and messages monitoring thread 608. The system even monitoring thread 602 generally handles rules relating to general system events such as internet connections 610, printer spooler jobs 611, user setting changes 612, and application launches 613. Rules associated with this thread 602 generally call for the core rules engine 510 to monitor Windows messaging events such as WMI Events, WM_X events, interrupts or callbacks. It should be noted that these events are passively detected by the rules-based engine 410, thereby minimizing intrusion into system resources and operation.

The device change monitoring thread controls rules related to hardware changes such as the addition or removal of appliances and devices 620, 621. Thus, the preferred embodiment may be able to detect if external data drives or playback devices are added to the computer system. In addition, rules related to the existence of removable media such as zip disks or CD Read/Write disks can be monitored 622 as well. Other device related rules 623 can be incorporated as well to detect installed hardware or plug-n-play items such as digital cameras, scanners, and GPS devices. Those skilled in the art will appreciate the various types of peripheral devices that are commonly coupled to PCs.

Those rules related to less frequent events or data gathering may be controlled by a timer based trigger monitoring thread 606. As mentioned above, probing a hard drive to determine if the drive is prematurely failing 632 can be done as infrequently as once a month. The timer thread 606 can keep track of such a rule as well as other infrequently executed rules such as checking ink levels in an attached printer 630, checking for BIOS updates 631, or determining if a broadband connection is present 633.

The preferred embodiment also provides for a special thread 608 for other various OS message or event monitoring. Rules associated with this particular thread are not necessarily classifiable in any particular thread group, but rather serve some specific purpose such as monitoring browser history 640 to gather internet browsing patterns. Similarly, rules relating to specific applications 641, 642 or specific files 643 may be registered with this thread. For example, if a page file (or swap file) is accessed frequently, this may indicate the excessive use of virtual memory and a rule might suggest that additional memory may improve performance. It should be noted that the threads and rules shown in FIG. 6 are provided to fully describe the preferred embodiment and are offered by way of example and not by way of limitation. Rules may be updated and developed independently of one another and may cover aspects not specifically disclosed herein. Rule descriptions included herein are not intended to limit the scope of applicable rules, but rather to indicate how such rules may be incorporated within the preferred embodiment.

The above discussion is meant to be illustrative of the principles and various embodiments of the present invention. Numerous variations and modifications will become apparent to those skilled in the art once the above disclosure is fully appreciated. For example, rules may be developed to determine if a laptop user connects and disconnects external devices and power often enough to suggest the use of a docking station. Similarly, users who download and install games from internet sites may be provided additional information on how to improve graphics and audio settings or to suggest other potential gaming websites. It is intended that the following claims be interpreted to embrace all such variations and modifications.

What is claimed is:

1. A personal computer system comprising:
a processor;
an input device for user interaction with the computer system coupled to the processor;
an output device for displaying information coupled to the processor; and
a usage enhancement software system executable on the processor;
wherein the usage enhancement system detects a usage pattern and if the usage pattern satisfies a trigger threshold, the usage enhancement system suggests a method for improving computer usage that is based on the usage pattern.

2. The personal computer system of claim 1 wherein the usage enhancement system comprises:
a rules-based engine comprising individual rules for different usage patterns; and
a message agent for displaying the methods for improving computer usage;
wherein the trigger threshold and method for improving computer usage for a given rule are associated with that rule and wherein when the rules-based engine determines that a usage pattern satisfies the trigger threshold, the rules-based engine transmits the method for improving computer usage to the message agent, which displays an alert message on the output device, said alert message indicating that a method for improving computer usage exists.

3. The personal computer system of claim 2 wherein the components of the usage enhancement system and the individual rules within the rules-based engine are modular and updateable by a backend device configured to download updates from a network connection.

4. The personal computer system of claim 3 wherein the rules-based engine executes in a highest protection layer of a computer operating system and occupies no more than 1% of the computer system resources.

5. The personal computer system of claim 4 wherein the individual rules are written in XML.

6. The personal computer system of claim 2 wherein when the message agent displays the alert message indicating that methods for improving computer usage exist, a computer user may elect to disable the alert message or to implement the methods now or at a later time.

7. The personal computer system of claim 6 wherein if a computer user elects to implement the methods for improving computer usage, the usage enhancement system instructs the user on how to incorporate the methods for improving computer usage and the usage enhancement system also, if elected by the user, automatically incorporates any methods for improving computer usage that do not require user interaction.

8. The personal computer system of claim 7 wherein if a computer user disables the alert message, the rules-based engine deactivates the rule that generated the alert message.

9. The personal computer system of claim 2 wherein the usage enhancement system further comprises:
an activity guide that provides grouped actions that relate to computer user interests;
wherein the grouping of actions in the activity guide is configurable by the customer and also by the results of the usage pattern detection performed by the rules-based engine.

10. A method for improving usage and efficiency of personal computer systems comprising:
monitoring usage patterns associated with said computer system; and
comparing usage patterns with a plurality of rules;
wherein if the usage patterns satisfy one of said rules, offering a computer user actions to improve the usage and efficiency of the computer system.

11. The method of claim 10 further comprising:
passively monitoring the usage patterns by detecting operating system messages, events, and interrupts.

12. The method of claim 11 further comprising:
actively monitoring the usage patterns by polling hardware devices and software applications;
wherein said active polling method uses no more than 1% of the personal computer system resources.

13. The method of claim 12 further comprising:
displaying the actions to improve the usage and efficiency of the computer system using a message agent;
offering the computer user the option of implementing the actions to improve the usage and efficiency of the computer system or alternatively; and
offering the computer user the option of disabling the actions to improve the usage and efficiency of the computer system.

14. The method of claim 13 further comprising:
displaying groups of related activities to the computer user in an activity guide;
wherein the selection of items to place within the groups of related activities is determined by detecting usage patterns.

15. The method of claim 14 further comprising:
comparing version information for components of the message agent, the activity guide, and the rules-based engine, including individual rules, against the latest version of each component available on a computer network;
updating any components that are not the latest version whenever the personal computer is connected to the network.

16. An extensible rule-based computer usage enhancement software package comprising:
a rule-based engine executable on a computer system to detect and gather computer usage patterns;
rules interpretable by the rule-based engine related to specific usage types; and
triggers within the rules that establish a threshold level for predetermined usage patterns above which suggestions are made to a computer user on ways to improve computer usage,
wherein all components of the software package reside on a single computer system and minimize active polling and executable components so as to occupy less than 10% of the computer system resources while the software package executes.

17. The rule-based computer usage enhancement software package of claim 16 wherein the software package occupies no more than 1% of system resources while executing on the computer system.

18. The rule-based computer usage enhancement software package of claim 17 wherein the rules exist in XML form.

19. The rule-based computer usage enhancement software package of claim 18 wherein the rule-based engine comprises:
a core rule engine that executes continuously as a system service;
executable rule engine extensions that load and run only when called by a rule and that are released after execution, said rule extensions providing usage pattern information to the rule engine;
a base rule engine extension that executes continuously and that gathers minimal information for the core rule engine;
wherein when the usage pattern information satisfies the trigger threshold, the rule-based computer usage enhancement system offers the suggestions on ways to improve computer usage.

20. The rule-based computer usage enhancement software package of claim 19 wherein the rule-based engine further comprises a parser for interpreting the rules.

21. The rule-based computer usage enhancement software package of claim 20 wherein the rule-based engine further comprises an evaluator for comparing trigger thresholds with usage pattern information provided by the rule engine extensions.

22. The rule-based computer usage enhancement software package of claim 21 wherein all rules and components of the rule-based computer usage enhancement software package are modular and automatically updateable via a network connection.

23. The rule-based computer usage enhancement software package of claim 22 wherein the suggestions on ways to improve computer usage are tailorable to individual computer users.

24. The rule-based computer usage enhancement software package of claim 22 wherein a common set of rules are installed in all computers in which the computer usage enhancement software package is installed, and wherein only those rules relevant to each computer system configuration and usage are activated.

25. The rule-based computer usage enhancement software package of claim 22 wherein the rule extensions provide usage pattern information based on information obtained from hardware devices.

26. The rule-based computer usage enhancement software package of claim 22 wherein the rule extensions provide usage pattern information from software applications.

27. The rule-based computer usage enhancement software package of claim 22 wherein the core rule engine that executes permanently as a system service controls multiple software threads, said software threads comprising:
a system monitor thread that monitors operating system messages, events and interrupts;
a device change thread that monitors device hardware and device media changes;
a time monitor thread that periodically polls device status; and
a special registered thread that monitors individual hardware devices or software applications;
wherein the rules are registered with one of the software threads and prioritized for evaluation by the system service.
